(19) United States
(12) Patent Application Publication
(10) Pub. No.: US 2019/0381703 A1
(43) Pub. Date: Dec. 19, 2019

(54) INFORMATION PROCESSING APPARATUS AND NON-TRANSITORY COMPUTER READABLE MEDIUM STORING PROGRAM

(71) Applicant: FUJI XEROX CO., LTD., TOKYO (JP)

(72) Inventor: Aoi TANIGUCHI, Kanagawa (JP)

(73) Assignee: FUJI XEROX CO., LTD., TOKYO (JP)

(21) Appl. No.: 16/435,582

(22) Filed: Jun. 10, 2019

(30) Foreign Application Priority Data
Jun. 19, 2018 (JP) 2018-116382

(51) Int. Cl. B29C 41/52; B29C 41/38; B29C 41/46; G06N 7/00

(52) U.S. Cl. CPC B29C 41/52; G06N 7/005; B29C 41/46; B29C 41/38

(57) ABSTRACT

An information processing apparatus includes an acquisition section that acquires a target temperature distribution of a model article having a target shape under a predetermined condition and an after-coating temperature distribution of a coated article obtained in a manner that a selected material is applied to the target shape and a surface of the model article is coated with the selected material under the condition, and an output section that outputs another material causing a difference between the target temperature distribution and the after-coating temperature distribution in a case of being applied to the coated article to be reduced.

### CROSS-REFERENCE TO RELATED APPLICATIONS

This application is based on and claims priority under 35 USC 119 from Japanese Patent Application No. 2018-116382 filed Jun. 19, 2018.

### BACKGROUND

### (i) Technical Field

The present invention relates to an information processing apparatus and a non-transitory computer readable medium storing a program.

### (ii) Related Art

In the related art, there is a technology in which analysis result shape of a product after performing all steps by CAE analysis is calculated, and a shape of a mold is determined based on a comparison between a target shape and the analysis result shape in a system of designing the shape of the mold of the product to be completed through plural steps (JP2006-107390A).

### SUMMARY

Thermal properties of a product in which coating has been performed on a surface of a body change in comparison to a body having a surface which has not been coated. However, in a technology in which a shape of a product or a shape of a mold for producing the product is changed, it is difficult to obtain a product coping with the change of the thermal properties by the coating.

Aspects of non-limiting embodiments of the present disclosure relate to an information processing apparatus and a non-transitory computer readable medium storing a program for designing a product coping with a change of thermal properties by coating in comparison to a case where a shape of a product or a shape of a mold for producing the product is changed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus which includes an acquisition section that acquires a target temperature distribution of a model article having a target shape under a predetermined condition and an after-coating temperature distribution of a coated article obtained in a manner that a selected material is applied to the target shape and a surface of the model article is coated with the selected material under the condition, and an output section that outputs another material causing a difference between the target temperature distribution and the after-coating temperature distribution in a case of being applied to the coated article to be reduced.

### BRIEF DESCRIPTION OF THE DRAWINGS

Exemplary embodiment(s) of the present invention will be described in detail based on the following figures, wherein:

FIG. 1 is a diagram illustrating an example of an overall configuration of a design support system to which an exemplary embodiment is applied;

FIG. 2 is a diagram illustrating a functional configuration of a data processing apparatus to which the exemplary embodiment is applied;

FIG. 3 is a diagram illustrating an example of information recorded in a body material database;

FIG. 4 is a diagram illustrating processing for a model article;

FIG. 5 is a diagram illustrating processing for a coated article;

FIG. 6 is a flowchart illustrating an example of a processing operation performed by a material determination unit; and

FIG. 7 is a flowchart illustrating a processing operation performed by a material selection unit in a selection step of a material.

### DETAILED DESCRIPTION

Hereinafter, an exemplary embodiment of the present invention will be described in detail with the reference to the accompanying drawings.

Overall Configuration of Design Support System

A design support system 1 in the exemplary embodiment is used for supporting a design of a product having a surface with a coating. Here, the product in the exemplary embodiment is a tangible object which includes a body having a predetermined shape and a coating performed on the surface of the body.

Examples of the body include a resin molded article formed by injection molding or press forming using a mold. The material of the body is not particularly limited so long as forming a coating on the surface of the body is allowed. For example, the material may be metal or wood.

The coating refers to a film formed by coating the surface of a body of a product with a coating material. In the exemplary embodiment, the thickness of the coating is assumed to be negligibly small (for example, about several tens of micrometers) with respect to the size (for example, about several tens of centimeters to several meters) of a product (body).

In a design for a product having a body and a coating, for example, a product having predetermined thermal properties is designed by performing designing of a shape and the like with a computer aided design (CAD) system and a heat transfer analysis by computer aided engineering (CAE), for the body.

Here, generally, thermal properties of a product having a body and a coating may change with properties of the coating, a change of a surface state of a product by the coating, or the like, in comparison to a state of only a body which is not subjected to coating.

In the above-described method of designing a product, a change of thermal properties by coating is not considered. Thus, in a case where a product having a body and a coating is produced based on this design, obtaining a product having thermal properties assumed at the design stage may not be possible.

On the contrary, as will be described below, the design support system 1 in the exemplary embodiment allows designing of a product coping with the change of the thermal properties by coating.

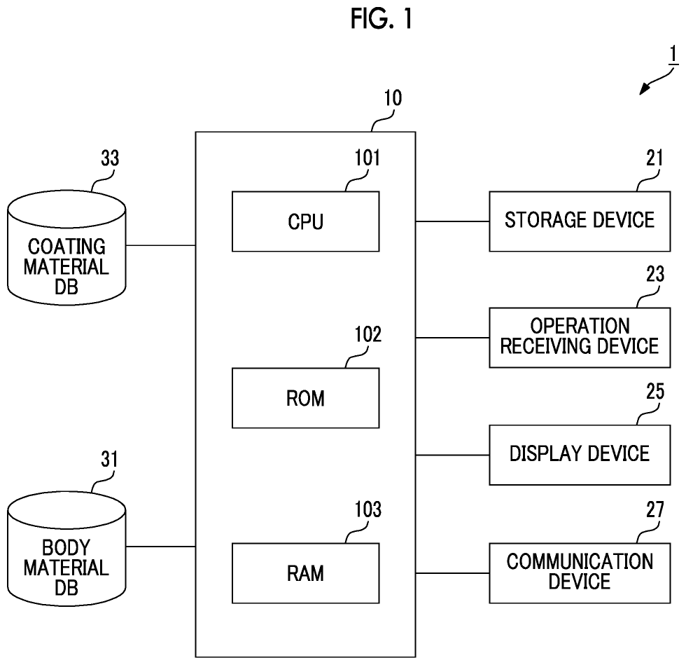

FIG. 1 is a diagram illustrating an example of the overall configuration of the design support system 1 to which the exemplary embodiment is applied.

The design support system 1 in the exemplary embodiment includes a data processing apparatus 10 as an example of an information processing apparatus, a storage device 21, an operation receiving device 23, a display device 25, and a communication device 27. The data processing apparatus 10 performs processing of data regarding a design of a product. The storage device 21 stores an application program and the like and is configured with a hard disk device and the like. The operation receiving device 23 receives an operation of a user. The display device 25 is used for inputting or providing information by displaying the information on a display screen. The communication device 27 performs a communication with an external device and the like. The design support system 1 in the exemplary embodiment further includes a body material database (DB) 31 in which information regarding the material of a body of a product has been recorded and a coating material database (DB) 33 in which information regarding the material of coating performed on a product has been recorded. Information recorded in the body material database 31 and the coating material database 33 will be described later.

The design support system 1 in the exemplary embodiment is realized by a computer.

The data processing apparatus 10 includes a central processing unit (CPU) 101, a read only memory (ROM) 102 in which an operating system or firmware realized by the CPU 101 has been stored, and a random access memory (RAM) 103 used as a work area of the CPU 101.

The storage device 21 stores an application program of realizing processing or functions which will be described later.

The operation receiving device 23 is, for example, an input device such as a mouse or a keyboard. The operation receiving device receives an input of information through a user interface screen displayed on the display screen of the display device 25.

The display device 25 is configured with, for example, a cathode ray tube (CRT) or a liquid crystal display. The display device is used for displaying the user interface screen.

The communication device 27 refers to, for example, a local area network (LAN) interface and is used for a communication with an external device. A communication method may be wired or wireless.

Functional Configuration of Data Processing Apparatus

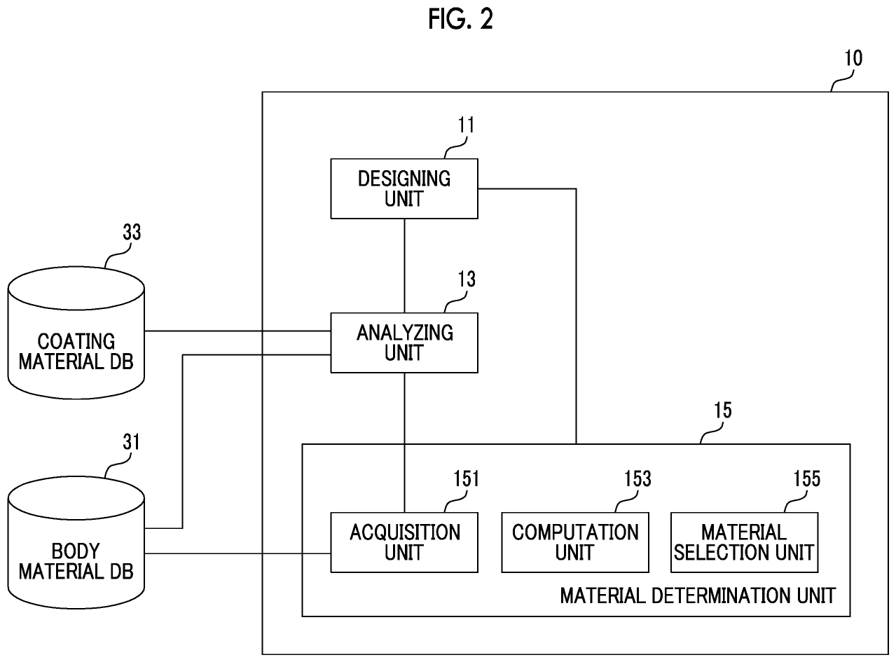

FIG. 2 is a diagram illustrating a functional configuration of the data processing apparatus 10 to which the exemplary embodiment is applied.

The data processing apparatus 10 in the exemplary embodiment includes a designing unit 11 that performs processing relating to a design of a product, and an analyzing unit 13 that analyzes the product designed by the designing unit 11 and is an example of a calculation section. The data processing apparatus 10 includes a material determination unit 15 that determines a material of the body of a product based on an analysis result and the like obtained by the analyzing unit 13.

Functions of the designing unit 11, the analyzing unit 13, and the material determination unit 15 are provided by executing an application program.

The designing unit 11 operates based on an input from the operation receiving device 23 (see FIG. 1) and designs a product with a computer aided design (CAD) system. More specifically, the designing unit 11 performs designing for the shape of the body of a product, the material of the body, and coating performed on the surface of the body, based on an input from the operation receiving device 23.

The designing unit 11 corrects the design for the shape of the body, based on a result obtained by a heat transfer analysis of the analyzing unit 13 (which will be described later). Although details thereof will be described later, in the data processing apparatus 10 in the exemplary embodiment, a model article of a product is designed by repeating a heat transfer analysis by the analyzing unit 13 and correction of a design by the designing unit 11 based on a result of the heat transfer analysis. In the exemplary embodiment, the model article means a design item having a target shape required as a product and thermal properties (target temperature distribution which will be described later) required for the product.

The analyzing unit 13 performs a heat transfer analysis with a computer aided engineering (CAE), based on the design by the designing unit 11. The analyzing unit outputs the analysis result to the material determination unit 15.

Specifically, the analyzing unit 13 acquires an analysis condition of the heat transfer analysis based on an input from the operation receiving device 23 and the like. Examples of the analysis condition include conditions (for example, the temperature, the humidity, and the airflow of the surrounding) for an environment in which a product as a target of a heat transfer analysis is placed, and conditions (for example, heating or cooling position and heating or cooling temperature) relating to heating or cooling of a product.

The analyzing unit 13 acquires information regarding a design of a product, from the designing unit 11. Specifically, the analyzing unit 13 acquires information of the shape of the body of a product, the material of the body, the material of a coating, the thickness of the coating, and the like, which have been designed by the designing unit 11, as information regarding the design of the product.

The analyzing unit 13 creates mesh data in which a shape of the body of a product, which has been acquired from the designing unit 11 has been divided into plural calculation lattices, for the shape of the body of the product.

The analyzing unit calculates the temperature at each calculation lattice under the analysis condition by solving a governing equation relating to heat transfer for each calculation lattice in the mesh data to which the acquired analysis condition is applied. Here, in the exemplary embodiment, a matrix representing a relationship between each calculation lattice in the mesh data and the temperature calculated by the analyzing unit 13, for the shape designed by the designing unit 11 is referred to as a temperature distribution.

Although details thereof will be described later, the analyzing unit 13 in the exemplary embodiment, the analyzing unit calculates a temperature distribution of a model article or a temperature distribution of a coated article which is a design item in which coating has been performed on the surface of the model article, as a temperature distribution which is an analysis result. In the following descriptions, the temperature distribution of the model article may be referred to as a target temperature distribution, and the temperature distribution of the coated article may be referred to as an after-coating temperature distribution.

The material determination unit 15 determines a material to be applied to the body of a coated article, based on the analysis result by the analyzing unit 13 and information regarding the material, which is recorded in the body material database 31.

The material determination unit 15 in the exemplary embodiment includes an acquisition unit 151, a computation unit 153, and a material selection unit 155. The acquisition unit 151 is an example of an acquisition section and acquires an analysis result by the analyzing unit 13. The computation unit 153 performs computation based on the analysis result acquired by the acquisition unit 151. The material selection unit 155 selects a material to be applied to the body of a coated article, based on a computation result by the computation unit 153. In the exemplary embodiment, an output section is configured by the computation unit 153 and the material selection unit 155 of the material determination unit 15 and the designing unit 11.

The acquisition unit 151 acquires target temperature distribution of the model article and the after-coating temperature distribution of the coated article as described above, as an analysis result by the analyzing unit 13.

The computation unit 153 calculates a difference between the target temperature distribution and the after-coating temperature distribution. The computation unit 153 compares the calculated difference to a predetermined threshold.

In a case where the difference is greater than the threshold, the material selection unit 155 selects a material to be applied to the body of the coated article, based on information regarding the material, which is recorded in the body material database 31. Although details thereof will be described later, the material selection unit 155 selects a material causing the difference between the target temperature distribution and the after-coating temperature distribution to be reduced in comparison to a provisional material, as the material to be applied to the body of the coated article.

Information Recorded in Database

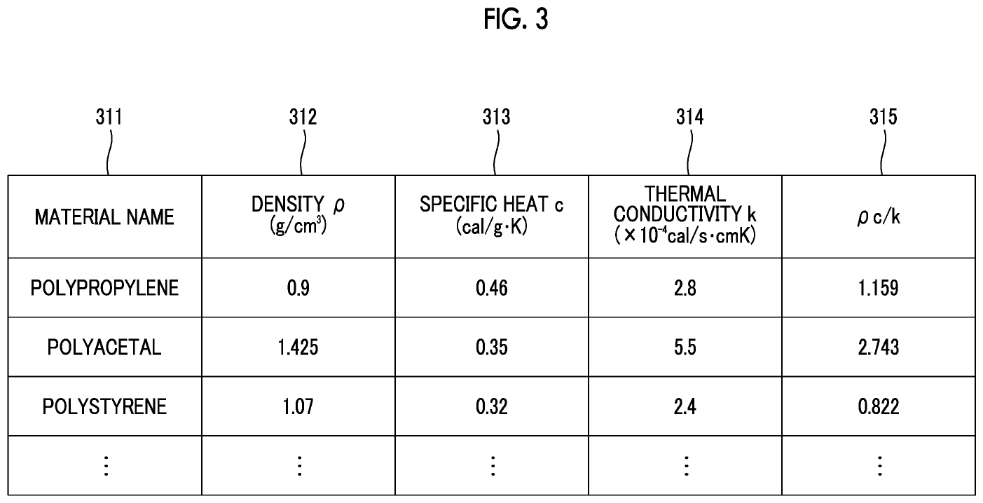

Information recorded in the body material database 31 will be described. FIG. 3 is a diagram illustrating an example of information recorded in the body material database 31. In the body material database 31, a material name 311 of a material usable as the material of the body of a product and physical properties relating to heat conduction for each material are recorded in association with each other. In the example illustrated in FIG. 3, as physical properties relating to heat conduction, density (ρ) 312, specific heat (c) 313, thermal conductivity (k) 314, and ρc/k 315 are recorded.

The numerical values of the physical properties of each material illustrated in FIG. 3 are just examples and are not necessarily accurate.

Although illustrations are omitted, in the coating material database 33, information regarding a coating material usable for a coating of a product and information required for calculating the after-coating temperature distribution of a coated article obtained by using each coating material are recorded in association with each other. Examples of the information required for calculating the after-coating temperature distribution include physical properties relating to heat conduction for each coating material or information regarding a surface state of the coating with each coating material. However, it is not limited thereto.

Processing Operation by Data Processing Apparatus

Processing operations performed by the data processing apparatus 10 in a case where a product is designed in the design support system 1 will be described. The following processing operations by the data processing apparatus 10 are realized by the CPU 101 (see FIG. 1) executing an application program.

In the data processing apparatus 10 in the exemplary embodiment, firstly, a model article having a target shape and a target temperature distribution is designed by the designing unit 11 and the analyzing unit 13. The designing unit 11 designs a coated article in which coating has been performed on the model article. Then, the analyzing unit 13 calculates an after-coating temperature distribution for the coated article. Then, the material determination unit 15 determines a material to be applied to the body of the coated article based on the target temperature distribution and the after-coating temperature distribution.

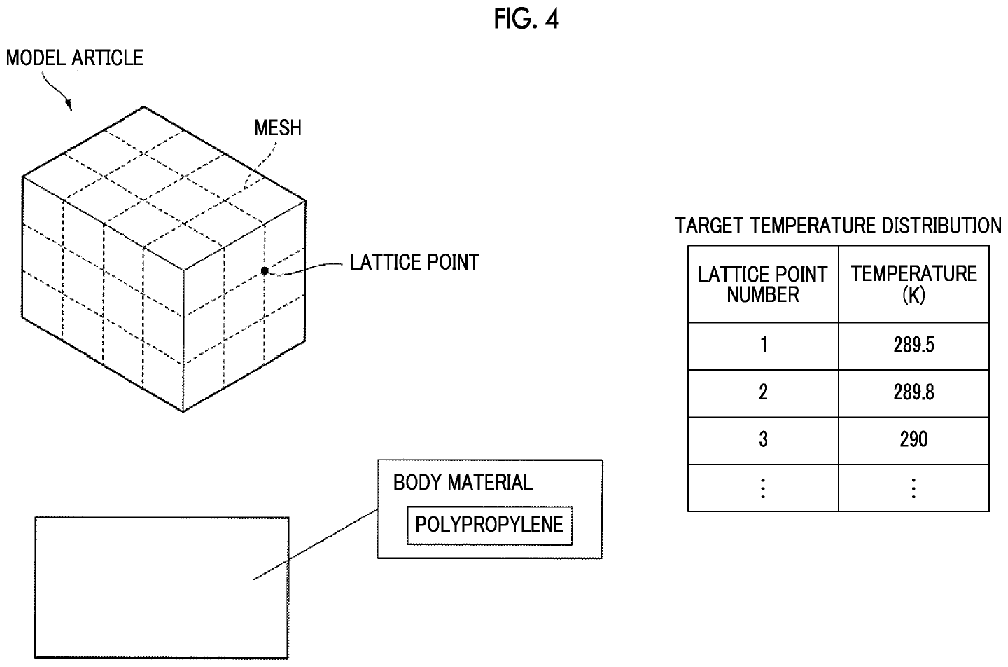

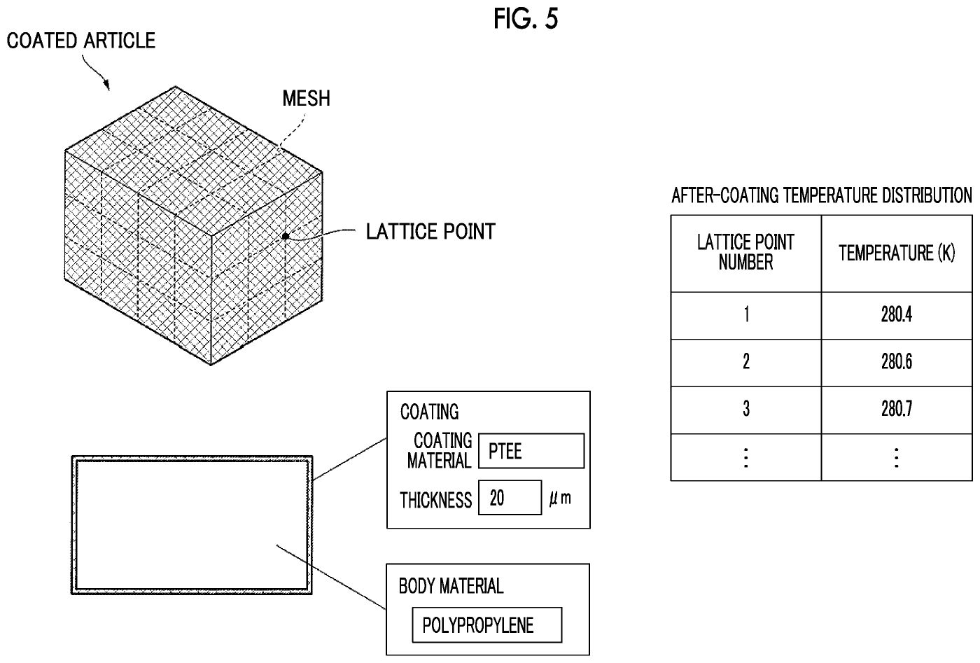

FIGS. 4 and 5 are diagrams illustrating a specific example of the processing operation performed by the data processing apparatus 10. FIG. 4 is a diagram illustrating processing for the model article. FIG. 5 is a diagram illustrating processing for the coated article in which coating has been performed on the model article.

The processing operations performed by the designing unit 11, the analyzing unit 13, and the material determination unit 15 will be specifically described below.

Design of Model Article by Designing Unit and Analyzing Unit

Firstly, the designing unit 11 designs a temporary shape (described as a provisional shape below) and a temporary material (described as a provisional material below) of the body of a product based on an input from the operation receiving device 23. The analyzing unit 13 performs a heat transfer analysis based on the provisional shape and the provisional material designed by the designing unit 11, under an analysis condition acquired through the operation receiving device 23, and calculates a temperature distribution. Then, the designing unit 11 corrects the provisional shape of the product such that the temperature distribution calculated by the analyzing unit 13 becomes approximate to the target temperature distribution required as the product.

With repeating the above steps, as illustrated in FIG. 4, a model article of a product, which includes the target shape and the target temperature distribution to which the provisional material is applied is designed. In the example, an example of a case where polypropylene is selected as the provisional material will be described. In the example, a temperature (289.5 (K), 289.8 (K), 290.0 (K), . . . ) is calculated, as the target temperature distribution, for each calculation lattice (lattice point number 1, 2, 3, . . . ) in mesh data created for the target shape.

As illustrated in FIG. 4, the model article has only a body and does not have a coating formed on the surface of the body. In other words, in the design and the analysis of the model article by the designing unit 11 and the analyzing unit 13, only the material and the shape of the body of the product are considered, and consideration for coating is not performed. In particular, as described above, the thickness of the coating is negligibly small with respect to the size of the body. Thus, the target shape of the model article and the shape of the coated article in which coating has been performed on the surface of the model article having a target shape may be considered as the identical shape.

The above-described design procedures of the model article by the designing unit 11 are just an example. The procedures are not particularly limited so long as designing a model article having a target shape and a target temperature distribution is possible.

Design of Coated Article by Designing Unit and Calculation of After-Coating Temperature Distribution by Analyzing Unit

In the data processing apparatus 10, the designing unit 11 designs a coated article in which coating has been performed on the surface of the model article. The analyzing unit 13 calculates an after-coating temperature distribution for the coated article designed by the designing unit 11.

Specifically, the designing unit 11 performs a design for a coating to be formed on the surface of a product, based on an input from the operation receiving device 23. As the design for the coating, designs of a coating material used in coating, the thickness of the coating, and the like are exemplified. The analyzing unit 13 performs a heat transfer analysis under an analysis condition similar to that for the target temperature distribution, by using the coating material and the thickness designed by the designing unit 11 and information regarding the coating material, which is recorded in the coating material database 33. Thus, as illustrated in FIG. 5, the after-coating temperature distribution is calculated for the coated article in which the provisional material (polypropylene) is applied to the body, and coating has been performed on the surface, and which has a target shape. In this example, a temperature (280.4 (K), 280.6 (K), 280.7 (K), . . . ) is calculated, as the after-coating temperature distribution, for each calculation lattice (lattice point number 1, 2, 3, . . . ) in mesh data created for the target shape.

Determination of Material by Material Determination Unit

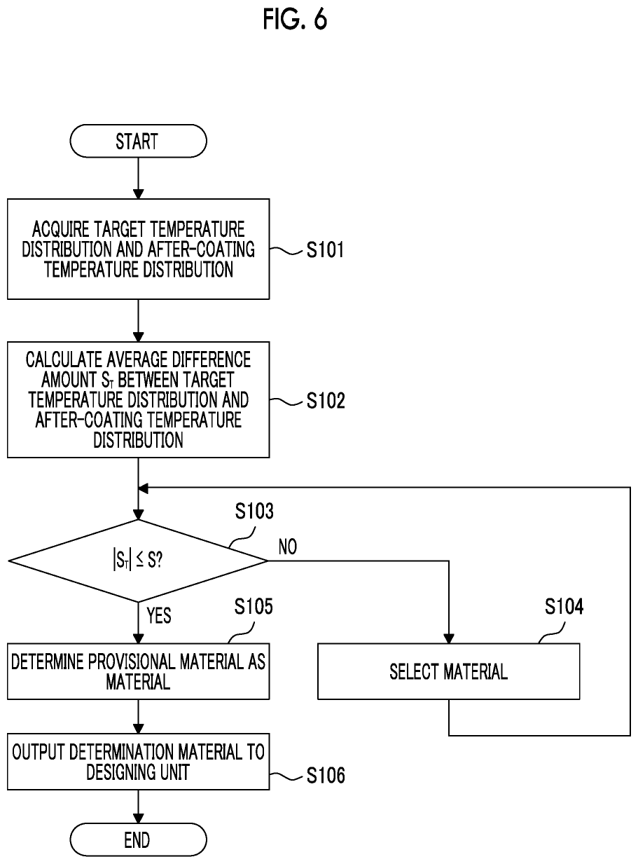

In the data processing apparatus 10, the material determination unit 15 performs a processing operation of determining a material to be applied to the body of a coated article based on the target temperature distribution and the after-coating temperature distribution. FIG. 6 is a flowchart illustrating an example of the processing operation performed by the material determination unit 15.

Firstly, in the material determination unit 15, the acquisition unit 151 acquires the target temperature distribution and the after-coating temperature distribution from the analyzing unit 13 (S101).

Then, in the material determination unit 15, the computation unit 153 calculates a difference between the target temperature distribution and the after-coating temperature distribution acquired in Step S101 (S102). Specifically, the computation unit 153 calculates an average difference amount S_{T} based on Expression (1), as the difference between the target temperature distribution and the after-coating temperature distribution.

S_{T}=Σ(T−T₀)/N (1)

Here, N indicates the total number of calculation lattice points in mesh data generated for the target shape. T indicates the temperature of each calculation lattice in the target temperature distribution. T₀ indicates the temperature of each calculation lattice in the after-coating temperature distribution.

Then, in the material determination unit 15, the computation unit 153 compares an absolute value |S_{T}| of the average difference amount S_{T} calculated in Step S102 to a predetermined threshold S (S103). In the following descriptions, the absolute value |S_{T}| of the average difference amount S_{T} may be simply described as an average difference amount |S_{T}|.

Here, the threshold S of the average difference amount |S_{T}| is a value which has been empirically determined. The threshold S may be a fixed value. For example, the threshold may be changed in accordance with the provisional material of the body, which has been selected in the design of the model article, a coating material selected in the design of the coated article, and the target shape.

In a case where the average difference amount |S_{T}| is greater than the predetermined threshold S (NO in S103), the material selection unit 155 in the material determination unit 15 selects a material to be applied to the body of the coated article based on information regarding the material, which is recorded in the body material database 31 (S104). Additionally, the material selection unit 155 selects a material causing the average difference amount |S_{T}| to be reduced, based on information regarding the material, which is recorded in the body material database 31. Selection of the material in Step S104 will be more specifically described later.

Then, the material determination unit 15 causes the process to return to Step S103 and repeats the processes, by using the material selected in Step S104 as the provisional material of the body. As will be described later, in Step S104, an after-coating temperature distribution and an average difference amount |S_{T}| in a case where the selected material has been applied are calculated. Thus, in Step S103, processing using the average difference amount |S_{T}| calculated in Step S104 is performed.

In a case where the average difference amount |S_{T}| is equal to or less than the predetermined threshold S (YES in S103), the material selection unit 155 in the material determination unit 15 determines the provisional material as the material of the body of the coated article (S105). The material of the body of the coated article, which has been determined by the material selection unit 155 in Step S105 is referred to as a determination material below.

In the material determination unit 15, the material selection unit 155 outputs the determination material determined in Step S105 to the designing unit 11 (S106).

The designing unit 11 notifies a user of the determination material through the display device 25. A method of notifying the user of the determination material is not particularly limited. For example, the designing unit 11 notifies the user of the determination material by changing the provisional material to be applied to the body of the coated article to the determination material on the user interface screen displayed in the display device 25.

In the exemplary embodiment, in Steps S101 to S106, the average difference amount S_{T} based on Expression (1) is used as the difference between the target temperature distribution and the after-coating temperature distribution. However, the difference between the target temperature distribution and the after-coating temperature distribution is not limited thereto. That is, another index may be used as the difference between the target temperature distribution and the after-coating temperature distribution, so long as evaluating a difference of thermal properties between the model article and the coated article is possible.

Details of Processing Operation by Material Selection Unit

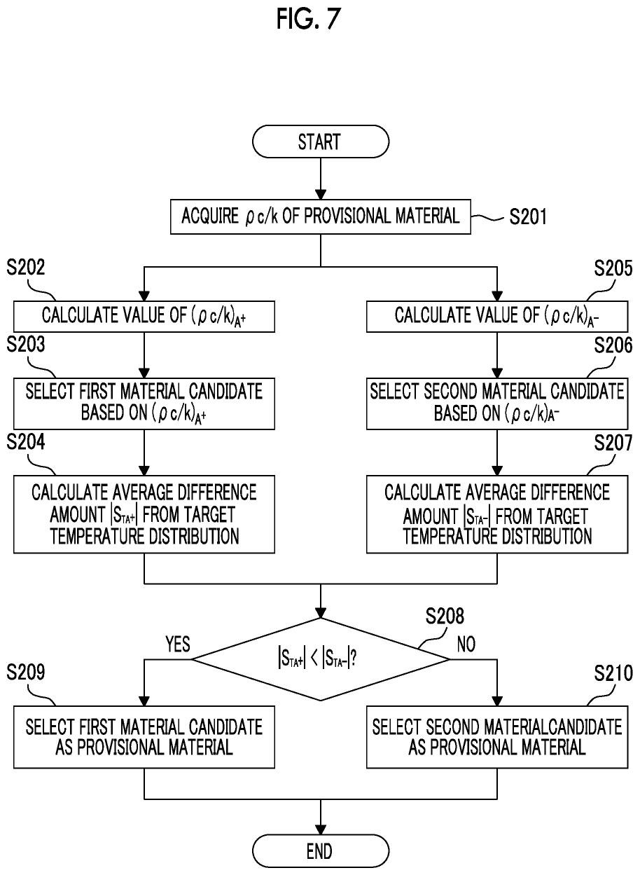

Details of the processing operation in which the material selection unit 155 selects the material in Step S104 will be described. FIG. 7 is a flowchart illustrating details of the processing operation performed by the material selection unit 155, in the selection step of the material in Step S104.

Firstly, the material selection unit 155 acquires the value of ρc/k as physical properties relating to heat conduction of the provisional material applied to the body of the coated article, from the body material database 31 (S201). In the example, since polypropylene is selected as the provisional material, the material selection unit 155 acquires 1.159 as ρc/k of polypropylene, from the body material database 31.

The material selection unit 155 calculates the value of (ρc/k)_{A+} based on Expression (2), from ρc/k of the provisional material, which has been acquired in Step S201 and the average difference amount |S_{T}| calculated in Step S104 (S202).

(ρc/k)_{A+}=ρc/k+α|S_{T}| (2)

Here, α indicates a correction factor and is a value which has been empirically determined. In the example, α has a value satisfying 0<α<1. Thus, (ρc/k)_{A-} has a value greater than ρc/k. α may be a fixed value. For example, α may be changed in accordance with the provisional material of the body, which has been selected in the design of the model article, a coating material selected in the design of the coated article, and the target shape.

Then, the material selection unit 155 selects a material in which the value of ρc/k is closest to the value of (ρc/k)_{A+} calculated in Step S202, as a first material candidate, from the body material database 31 (S203). In the example, polyacetal is selected from the body material database 31, as the first material candidate.

The analyzing unit 13 calculates an after-coating temperature distribution for a coated article to which the first material candidate selected in Step S203 has been applied as the material of the body instead of the provisional material. The average difference amount |S_{TA+}| from the target temperature distribution is acquired in a manner similar to the above-described Expression (1) (S204). In the example, the after-coating temperature distribution for a coated article in which the material of the body has been changed from polypropylene as the provisional material to polyacetal as the first material candidate is calculated, and the average difference amount |S_{TA-}| is acquired.

The material selection unit 155 calculates the value of (ρc/k)_{A-} based on Expression (3) from ρc/k of the provisional material, which has been acquired in Step S201 and the absolute value |S_{T}| of the average difference amount S_{T}, which has been calculated in Step S104 (S205), similar to Step S202.

(ρc/k)_{A-}=ρc/k−α|S_{T}| (3)

Here, α is a correction factor identical to that in the above-described Expression (2). Thus, (ρc/k)_{A-} has a value less than that of ρc/k.

Then, similar to Step S203, the material selection unit 155 selects a material in which the value of ρc/k is closest to the value of (ρc/k)_{A-} calculated in Step S205, as a second material candidate, from the body material database 31 (S206). In the example, polystyrene is selected from the body material database 31, as the second material candidate.

The analyzing unit 13 calculates an after-coating temperature distribution for a coated article in which the second material candidate selected in Step S206 instead of the provisional material has been applied as the material of the body. Similar to the above-described Expression (1), the average difference amount |S_{TA-}| from the target temperature distribution is acquired (S207). In the example, the after-coating temperature distribution is calculated for the coated article in which the material of the body has been changed from polypropylene as the provisional material to polystyrene as the second material candidate, and the average difference amount |S_{TA-}| from the target temperature distribution is acquired.

The processing operation of acquiring the average difference amount |S_{TA+}| for the first material candidate from the target temperature distribution, which is performed in Steps S202 to S204 and the processing operation of acquiring the average difference amount |S_{TA-}| for the second material candidate from the target temperature distribution, which is performed in Steps S205 to S207 may be performed in parallel with each other or may be sequentially performed.

Then, the material selection unit 155 compares the average difference amount |S_{TA+}| for the first material candidate, which has been acquired in Step S204 and the average difference amount |S_{TA-}| for the second material candidate to each other (S208).

In a case where the average difference amount |S_{TA+}| for the first material candidate is less than the average difference amount |S_{TA-}| for the second material candidate (YES in S208), the material selection unit 155 selects the first material candidate as the provisional material of the body (S209).

In a case where the average difference amount |S_{TA+}| for the first material candidate is equal to or greater than the average difference amount |S_{TA-}| for the second material candidate (NO in S208), the material selection unit 155 selects the second material candidate as the provisional material of the body (S210).

Additionally, in Step S209 and Step S210, the average difference amount |S_{TA+}| and the average difference amount |S_{TA-}| are compared to each other, and the material candidate having the smaller average difference amount is selected as the provisional material.

In the example, the material selection unit 155 compares the average difference amount |S_{TA+}| calculated for polyacetal as the first material candidate and the average difference amount |S_{TA-}| calculated for polystyrene as the second material candidate, to each other. The material selection unit 155 selects the material candidate having the smaller average difference amount, as the provisional material.

Thus, the material determination unit 15 ends the selection step of the material by the material selection unit 155 in Step S104. The material determination unit causes the process to return to Step S103 described above and continues the processing.

That is, in Step S103, the average difference amount |S_{TA+}| or |S_{TA-}| for the first material candidate or the second material candidate selected in Step S209 or Step S210 is used as the average difference amount |S_{T}| and is compared to the threshold S. The processes of Steps S103 and S104 (specifically, Steps S201 to S210) are repeated until the average difference amount |S_{T}| becomes equal to or less than the threshold S.

Here, the reason of using the value of ρc/k as the physical properties relating to heat conduction in a case where the material selection unit 155 selects the first material candidate and the second material candidate is as follows.

Expression (4) represents a heat conduction equation.

Δ·T+q/k=(ρc/k)·(∂T/∂τ) (4)

Here, k indicates thermal conductivity, ρ indicates density, and c indicates specific heat. q indicates the quantity of heat generated per unit time, Δ·T indicates a spatial change of a temperature distribution in a temperature field, and ∂T/∂τ indicates a temporal change of the temperature distribution in the temperature field.

According to the heat conduction equation of Expression (4), in a case where the shape and the analysis condition (boundary condition) of a design item as a target of a heat transfer analysis are identical, and the design item does not emit heat, a factor influencing the temperature distribution of the design item is ρc/k. The value of ρc/k is uniquely determined in accordance with the type of material.

From the above descriptions, the after-coating temperature distribution of a coated article which is a design item in which coating has been performed on the body may change by selecting the first material candidate and the second material candidate based on ρc/k, and the material of the body, which causes the after-coating temperature distribution to be approximate to the target temperature distribution may be selected.

As described above, the after-coating temperature distribution of the coated article changes by selecting the first material candidate and the second material candidate based on ρc/k. However, the reason that the material selection unit 155 in the exemplary embodiment selects both the first material candidate having a large value of ρc/k and the second material candidate having a small value of ρc/k is as follows.

That is, the after-coating temperature distribution may vary depending on an interrelation and the like between the material of the body and the coating material used in coating. Normally, in a case where the material of the body is changed, in many cases, whether or not the after-coating temperature distribution is approximate to the target temperature distribution (whether or not the average difference amount |S_{T}| is reduced) is not determined until the heat transfer analysis is practically performed for a coated article to which the material has been applied.

Therefore, in the exemplary embodiment, the material causing the average difference amount |S_{T}| to be reduced is selected as the material to be applied to the body of a product, in a manner that the first material candidate and the second material candidate are selected based on ρc/k, and the practical average difference amount |S_{T}| is obtained by performing the heat transfer analysis for each of the first material candidate and the second material candidate.

In the exemplary embodiment, the first material candidate and the second material candidate are selected based on ρc/k. However, the number of material candidate to be selected may be equal to or greater than 3.

As described above, according to the design support system 1 in the exemplary embodiment, in the design of a product in which coating has been performed on the surface of the body, a material causing the difference between the after-coating temperature distribution and the target temperature distribution for a coated article in which coating has been performed on the surface of the body to be reduced is output as the material of the body. Thus, a product coping with the change of the thermal properties by coating is obtained by employing a material causing the difference between the after-coating temperature distribution and the target temperature distribution to be reduced, as the material of the body.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an acquisition section that acquires a target temperature distribution of a model article having a target shape under a predetermined condition and an after-coating temperature distribution of a coated article obtained in a manner that a selected material is applied to the target shape and a surface of the model article is coated with the selected material under the condition; and
an output section that outputs another material causing a difference between the target temperature distribution and the after-coating temperature distribution in a case of being applied to the coated article to be reduced.

2. The information processing apparatus according to claim 1,
wherein, in a case where the difference between the target temperature distribution and the after-coating temperature distribution is greater than a predetermined threshold, the output section outputs the other material.

3. The information processing apparatus according to claim 2,
wherein the output section outputs a material causing the difference between the target temperature distribution and the after-coating temperature distribution to be equal to or less than the predetermined threshold, as a material of the coated article.

4. The information processing apparatus according to claim 1, further comprising:
a calculation section that acquires information regarding the coating and calculates the after-coating temperature distribution based on the target shape and the information regarding the coating,
wherein the acquisition section acquires the after-coating temperature distribution calculated by the calculation section.

5. The information processing apparatus according to claim 4,
wherein the output section outputs the other material causing the difference between the target temperature distribution and the after-coating temperature distribution to be reduced, to the calculation section, and
the calculation section calculates the after-coating temperature distribution again in a state of applying the other material output by the output section.

6. The information processing apparatus according to claim 5,
wherein the output section repeatedly outputs the other material causing the difference between the target temperature distribution and the after-coating temperature distribution which has been calculated again by the calculation section to be reduced, to the calculation section until the difference between the target temperature distribution and the after-coating temperature distribution becomes equal to or less than a predetermined threshold.

7. The information processing apparatus according to claim 4,
wherein the output section
selects a plurality of material candidates and outputs the plurality of selected material candidates to the calculation section, and
selects the other material from the plurality of material candidates based on after-coating temperature distributions which have been obtained by applying the material candidate and calculated by the calculation section and outputs the other material.

8. The information processing apparatus according to claim 7,
wherein the output section selects the plurality of material candidates based on physical properties related to heat conduction.

9. A non-transitory computer readable medium storing a program causing a computer to realize:
a function of acquiring a target temperature distribution of a model article having a target shape under a predetermined condition;
a function of acquiring an after-coating temperature distribution of a coated article obtained in a manner that a selected material is applied to the target shape and a surface of the model article is coated with the selected material under the condition; and
a function of outputting another material causing a difference between the target temperature distribution and the after-coating temperature distribution in a case of being applied to the coated article to be reduced.

10. An information processing apparatus comprising:
acquisition means for acquiring a target temperature distribution of a model article having a target shape under a predetermined condition and an after-coating temperature distribution of a coated article obtained in a manner that a selected material is applied to the target shape and a surface of the model article is coated with the selected material under the condition; and
output means for outputting another material causing a difference between the target temperature distribution and the after-coating temperature distribution in a case of being applied to the coated article to be reduced.
